(19) United States
(12) Patent Application Publication
(10) Pub. No.: US 2009/0249981 A1
(43) Pub. Date: Oct. 8, 2009

(54) COMPOSITION FOR HYDRAULIC SETTING

(76) Inventor: Philippe Pichat, Paris (FR)

Correspondence Address: STITES & HARBISON PLLC, 1199 NORTH FAIRFAX STREET, SUITE 900, ALEXANDRIA, VA, 22314, US

(21) Appl. No.: 12/438,181

(22) PCT Filed: Aug. 8, 2007
(86) PCT No.: PCT/FR2007/001354

§ 371 Date: Feb. 23, 2009

(30) Foreign Application Priority Data
Aug. 21, 2006 (FR) 0607425

(51) Int. Cl. C04B 14/28; B29C 39/02

(52) U.S. Cl. 106/817; 264/299

(57) ABSTRACT

The object of the invention is an hydraulic setting composition comprising: (a) an aggregate comprising calcium carbonate; (b) an aggregate comprising silica; (c) alkaline hydroxide; and (d) a suitable quantity of water, characterized in that it contains less than 20% by weight of component (c) and that the sum of the content of cations other than Si and Ca of components a) and b) is less than 10%.

The present invention relates to the field of hydraulic setting materials.

Hydraulic setting materials such as cement and concrete are known. The uses of concrete produced from aggregates bound by Portland cement or (hydraulic) lime are many (see, for example, the article “Les Liants minéraux, propriétés, usages, évolution”, Ph. Pichat, “La Technique Moderne” No. 1, 2, 3, 2001, pages 23-31).

The production of the Portland cement and lime used for agglomerating the aggregates (stone, sand, etc.) is, however, accompanied by the release of carbon dioxide into the environment.

It is now known that the release of this gas in large amounts produces a greenhouse effect in the atmosphere and can contribute to climate change.

This is the result on the one hand of the decarbonatation of the limestone to quick lime, which reaction takes place during the preparation of the clinker. The production of one tonne of Portland cement clinker is thus accompanied by the release of approximately 0.5 tonne of carbon dioxide. It is also the result of the combustion of the carbon-containing products used to achieve the temperature of 1450° C. which is necessary for the reaction.

Portland cement also has other disadvantages.

In particular, it requires the supply of a considerable amount of energy. Thus, the clinker must be crushed and then ground to give Portland cement in powder form. The Portland cement particles in fact have sizes of the order of 50 μm, because it is their surface that is mainly active in forming the adhesive (calcium aluminates, silicates, etc.) which bind the aggregates together.

In addition, the cement is contaminated with chromium VI, which has not inconsiderable toxicity and can cause allergies. From an aesthetic point of view, Portland cement has a grey colour which denatures the appearance of the aggregates. The setting speed is highly dependent on the temperature and is low below about 5° C., a handicap which restricts the activity of BTP [building and public works] especially in winter. Finally, the cement paste exhibits shrinkage whereas the aggregates are rigid, which causes stresses which can give rise to the appearance of cracks.

Portland cement concrete is manufactured by adding said cement, water, to aggregates. According to their decreasing sizes, the latter are commonly referred to as coarse gravel, fine gravel (order of 1 cm), sand (order of a millimetre), fines and fillers.

The aggregates used in the manufacture of concretes and mortars must satisfy various constraints. Accordingly, they preferably exhibit an appropriate particle size curve in order to minimise voids and therefore the amount of binder necessary to render the medium continuous.

An object of the invention is to propose a composition which exhibits hydraulic setting similar to cement but does not have one or more of the mentioned disadvantages, especially which releases less carbon dioxide.

That object is achieved, according to a first aspect of the invention, by means of a hydraulic setting composition comprising:
(a) an aggregate comprising calcium carbonate;
(b) an aggregate comprising silica;
(c) alkaline hydroxide, especially sodium hydroxide; and
(d) an appropriate amount of water,
characterised in that it contains less than 20%, preferably less than 15% and most particularly less than 5% by weight of component (c).

It has been found, surprisingly, that a composition comprising the mentioned components is capable of setting even in the presence of a very small amount of alkaline hydroxide.

According to one embodiment, the composition comprises from 0.1 to 10% by weight of component (c).

In other words, the weight ratio between component (c) and components (a) and (b) is less than 20%, preferably less than 15% and most particularly less than 10%.

Components (a) and (b) are preferably supplied by a siliceous limestone aggregate. Component (a) or (b) can be or can contain a waste product.

Advantageously, component (b) is a siliceous aggregate.

The composition preferably comprises from 10 to 60% by weight of each of component (a) and component (b).

In addition, the composition preferably comprises little water, generally less than 10% by weight and in particular less than 5% by weight.

According to a second aspect, the invention relates to a process for the preparation of a monolithic material, comprising a step in which:
a composition according to the invention is prepared;
the composition is placed in a mould; and
the composition is allowed to harden.

According to a third aspect, the invention relates to a monolithic material obtainable by the described process.

According to a final aspect, the invention relates to the use of the material so obtained as a building or repair material.

Within the present description, the term “cement” is intended to denote a mixture of ground inorganic materials which, by addition of water, form a binding paste which is capable of hardening and binding granular materials together.

The term “aggregates” is intended to denote divided solids of variable size which are generally obtained naturally, for example from quarries or sand pits, and which include powders but also aggregates such as sand, gravel and crushed materials. The aggregates used within the scope of the invention generally have an average size of from 0.1 to 20 mm.

The chemical reactions involved in the setting of the described composition differ from those which occur in the manufacture of a Portland cement concrete.

The reactions involved in the setting of Portland cement take place substantially when the cement, which is an insoluble heterogeneous reagent, comes into contact with water, like an “adhesive” in contact with water.

In the composition according to the invention, one of the reagents is soluble and available in solution in ionic form, that is to say in the form of elements having a size of the order of 50 Å. The solution reacts with the limestone and siliceous aggregates to create bonds between them.

The aggregates of the composition comprise limestone aggregates and siliceous aggregates. According to one embodiment, the aggregates used comprise siliceous limestone aggregates, which contain both silica and limestone.

The aggregates are generally obtained naturally and accordingly contain other elements. Advantageously, the aggregates contain few cations other than silicon and calcium, such as especially aluminium, iron, magnesium, titanium, potassium and sodium.

Therefore, the sum of the cations other than calcium and silicon, and especially aluminium, contained in the aggregates is preferably less than 10%, more preferably less than 5% and in particular less than 2% by weight.

Within this context it is also possible, however, to use aggregates containing or constituted by residual materials. For different sources and types of appropriate residual materials, reference is made, for example, to the article “La réutilisation des déchets dans les travaux publics et la construction”, Ph. Pichat, Revue des Matériaux de construction No. 697, November-December 1975, pp. 331-2.

The silica can be in crystalline or amorphous form. When it is crystalline, it can especially be a quartz or a cristobalite.

The soluble reagent is an alkali metal hydroxide, such as sodium hydroxide, potassium hydroxide, alone or in a mixture. It is preferably sodium hydroxide. It can also be reagents that release the alkali metal hydroxide in situ, such as especially the carbonates of those metals.

By adding sodium hydroxide in the form of a solution, it is advantageously possible to add at the same time the water that is required for the reaction to take place.

The amount of water is adjusted in order to ensure that the composition sets well. The appropriate amount of water depends on several factors, including especially the particle size of the aggregates and their degree of dryness. In general, water is added in an amount sufficient to ensure granulation of the mixture and the formation of hydrated compounds, while taking care to avoid an excessive amount which results in oozing.

The process for preparing and using the composition is simple.

The various components are mixed intimately and then placed in a mould. Mixing can be carried out in one or two stages. In particular, it is possible to mix the alkaline hydroxide with the aggregate comprising calcium carbonate and to add the aggregate comprising silica in a second stage.

Agitation of the mixture is preferably carried out so as to take advantage of the thixotropic properties of the mixture (planetary movement, shear forces, etc.). The order in which the reagents are added during mixing is not critical.

The mixture can then be put in place directly, for example in a mould, or between panels, or on a substrate by vibro-compaction. The other processes conventional for hydraulic setting compositions, for example moulding, projection, injection or pouring, can also be envisaged.

The composition solidifies by hydraulic setting, which takes place within a period of from several hours to several days. Hardening can be followed by mechanical resistance measurements.

Although the process has not been wholly elucidated, it is assumed that, in the case of NaOH as the alkaline hydroxide, it involves the following reactions, in aqueous solution:

2NaOH+CaCO₃ [symbol] Ca(OH)₂+Na₂CO₃ (1)

Ca(OH)₂+SiO₂ [symbol] [CaO,SiO₂,H₂O] (2)

Na₂CO₃+CaCO₃ [symbol] [Ca Na₂(CO₃)₂] (3)

Reaction (1) results in the in situ formation in the composition of lime and sodium carbonate. The lime reacts with the silica according to equation (2) to yield a sparingly soluble composition, mainly tobermorite. The sodium carbonate, on the other hand, reacts with the calcium carbonate to give a mixed carbonate, which precipitates, depending on the amount of water, in the form of pirsonnite (2 molecules of water) or gaylussite (5 molecules of water), which are also sparingly soluble.

Materials investigation techniques (electron microscopy and X-ray diffraction) confirm the presence of those chemical species in the solid obtained from the hydraulic setting composition.

The reaction as a whole can be represented by the equation:

2NaOH+2CaCO₃+SiO₂+H₂O [symbol] [CaO,SiO₂, H₂O]+CaNa₂ (CO₃)₂

The monolith obtained from the composition, when subjected to the X31211 lixiviation test for 28 days, gives a pH of approximately 11, which shows that the alkaline hydroxide has been converted.

Advantageously, the described composition requires none or only a few of the adjuvants conventionally employed in cement-based compositions, such as accelerators and retarding agents, anti-clay agents, chromium reducers.

However, the composition can contain certain additives in order to modify its properties and/or appearance, such as fillers, strengthening agents, pigments, colourings.

The composition does not substantially alter the appearance of the aggregates, thus rendering the material very aesthetic. Therefore, the composition is particularly valuable for a mortar-type application for coatings and floor coverings. It can also be used as a slurry, especially for sub-floor injection.

The invention will be described in greater detail by means of the following non-limiting examples.

### EXAMPLES

### Example 1

1230 g of a 0-4 mm siliceous aggregate from Chazeuil (Nièvre, France), the composition and particle size distribution of which are indicated in Tables 1 and 2, are introduced into the mixing bowl of a planetary mixer. In this sand, silicon is present principally in the form of silica and calcium in the form of calcium carbonate.

240 g of calcium carbonate having a particle size greater than 50 μm and 104 cm³ of 16.7 N NaOH are then introduced. After mixing for 5 minutes, the composition, which has taken on a granular appearance, is introduced into a Teflon mould of dimensions 4×4×16 cm.

The sample hardens on the surface after several hours and can be removed from the mould after several days.

The sample is evaluated by measuring the 28-day compressive strength and has a compressive strength of 80 MPa. The sample is subjected to the X 30417 lixiviation test described previously. The pH is below 12, that is to say below the pH resulting from the lixiviation of a conventional Portland cement. The results of the evaluation are summarised in Table 6.

TABLE 1
Composition of the siliceous aggregate from Chazeuil

| Elements | Si | Ca | Fe | Mg | Ti | K | Na |
|---|---|---|---|---|---|---|---|
| Percentage [%] | 21.1 | 0.7 | 1.5 | 0.4 | 0.2 | 2.1 | 1.1 |

TABLE 2
Particle size distribution of the siliceous aggregate from Chazeuil

| Residue at [mm] | Percentage [%] |
|---|---|
| 5 | 0 |
| 2 | 22.42 |
| 1 | 21.33 |
| 0.2 | 53.94 |
| 0.1 | 1 |
| 0.05 | 0.32 |
| 0.04 | 0.03 |
| Total | 99.01 |

### Example 2

1073 g of a 0-6 mm limestone aggregate from the place called Entrains (Nièvre, France), the composition and particle size distribution of which are indicated in Tables 3 and 5, are introduced into the mixing bowl of a planetary mixer. 1230 g of a 0-3 mm siliceous aggregate from Meillers (Allier, France), the composition and particle size distribution of which are indicated in Tables 4 and 5, 104 cm³ of 16.7 N NaOH and 107.66 cm³ of demineralised water are added.

After mixing for 5 minutes, the composition, which has taken on a granular appearance, is poured into a Teflon mould of suitable dimensions.

The results of the evaluation are summarised in Table 6.

TABLE 3
Composition of the limestone aggregate from Entrains

| Elements | Si | Ca | Fe | Mg | Ti | K | Na |
|---|---|---|---|---|---|---|---|
| Percentage | 0.5 | 34 | 0.1 | <0.1 | 0.1 | <0.1 | <0.1 |

TABLE 4
Composition of the siliceous aggregate from Meillers

| Elements | Si | Ca | Fe | Mg | Ti | K | Na |
|---|---|---|---|---|---|---|---|
| Percentage | 30.1 | <0.1 | 0.3 | 0.3 | <0.1 | <0.1 | <0.1 |

TABLE 5
Particle size distribution of the aggregates
from Meillers and Entrains

| | Percentage [%] | Percentage [%] |
|---|---|---|
| Residue at [mm] | Meillers | Entrains |
| 5 | 0 | 8.42 |
| 2 | 12.56 | 30.50 |
| 1 | 24.74 | 22.62 |
| 0.2 | 48.82 | 30.76 |
| 0.1 | 7.55 | 3.83 |
| 0.05 | 3.63 | 0 |
| 0.04 | 0.25 | 0.21 |
| Total | 97.55 | 96.34 |

### Example 3

A hydraulic setting composition is prepared as in Example 2, but 312.33 cm³ of 16.7 N NaOH and no water are added.

### Example 4

A hydraulic setting composition is prepared as in Example 2, but 156 cm³ of 16.7 N NaOH and no water are added.

The results of the evaluation are summarised in Table 6.

### Example 5

A hydraulic setting composition is prepared as in Example 2, but 69.3 cm³ of 16.7 N NaOH and no water are added.

The results of the evaluation are summarised in Table 6.

### Example 6

A hydraulic setting composition is prepared as in Example 2, but 52.39 cm³ of 16.7 N NaOH and no water are added.

The results of the evaluation are summarised in Table 6.

### Example 7

A hydraulic setting composition is prepared as in Example 2 with 900 g of normalised siliceous sand certified as complying with ISO 679 (Société nouvelle du Littoral, Leucate, France), 175 g of calcium carbonate, 125 g of silica, predominantly in the form of cristabolite, and 100 cm³ of 10 N NaOH.

The 28-day compressive strength is found to be low. The results of the evaluation are summarised in Table 6.

### Example 8

A hydraulic setting composition is prepared as in Example 7, but with a larger amount of sodium hydroxide. 900 g of normalised siliceous sand certified as complying with ISO 679 (Société nouvelle du Littoral, Leucate, France), 225 g of calcium carbonate, 105 g of silica, predominantly in the form of cristobalite, and 175 cm³ Of 10 N NaOH are mixed in.

The 28-day compressive strength is found to be better when the amount of sodium hydroxide is greater.

The results of the evaluation are summarised in Table 6.

### Example 9

In order to study the effect of adding calcium chloride, a hydraulic setting composition is first prepared as in Example 2 with 900 g of normalised siliceous sand certified as complying with ISO 679 (Société nouvelle du Littoral, Leucate, France), 175 g of calcium carbonate, 125 g of silica, predominantly in the form of cristobalite, and 91 cm³ of 10 N NaOH

The results of the evaluation are summarised in Table 6.

### Example 10

The same composition is then prepared, but a portion of the calcium carbonate is replaced by calcium chloride. Accordingly, 166 g of calcium carbonate, 118.5 g of silica, predominantly in the form of cristabolite, 100 cm³ of 10 N NaOH and 15 g of CaCl₂ are added.

The 28-day compressive strength is found to be improved.

The results of the evaluation are summarised in Table 6.

TABLE 6
Physical properties of the monoliths obtained

| | 28-day compressive strength | | Lixiviation | Solubility |
|---|---|---|---|---|
| Example | [MPa] | | pH | [g/l] |
| 1 | 80 at 28 | d | <12 | <10 |
| 2 | 2.7 at 27 | d | <12 | <10 |
| 3 | 29/69 | d | <12 | <10 |
| 4 | 13/69 | d | <12 | <10 |
| 5 | 8/70 | d | <12 | <10 |
| 6 | 15/109 | d | <12 | <10 |
| 7 | 2.7 at 28 | d | <12 | <10 |
| 8 | 19.8 at 28 | d | <12 | <10 |
| 9 | 3.2 at 28 | d | <12 | <10 |
| 10 | 31.8 at 28 | d | <12 | <10 |

### Example 11

333 kg of normalised siliceous sand certified as complying with ISO 679 (Société nouvelle du Littoral, Leucate, France) and 666 kg of coarse siliceous gravel from Meillers having a particle size of 0-22 mm are introduced into the mixing bowl of a planetary mixer. 480 kg of limestone filler having a particle size less than 100 μm, 18 kg of water and 1 0 litres of 16.7 N sodium hydroxide are then introduced.

After mixing for 5 minutes, the concrete composition is introduced into a suitable mould.

The sample hardens within a few hours and can be removed from the mould within several days.

The sample is evaluated in particular by measuring the 8-day compressive strength and has a compressive strength of 6 MPa.

### Example 12

250 kg of limestone filler containing 90% CaCO₃ having a particle size at 100% <700 μm from the place called Cruas (Ardèche, France) and 700 kg of normalised siliceous sand certified as complying with ISO 679 (Société nouvelle du Littoral, Leucate, France) are introduced into the mixing bowl of a planetary mixer. 212 kg of anhydrous sodium carbonate and 176 kg of water are then added.

After mixing for 5 minutes, the composition is introduced into a suitable mould.

The sample hardens at the surface within several hours and can be removed from the mould within several days.

The sample is evaluated in particular by measuring the 79-day compressive strength and has a compressive strength of 90 MPa.

1. Hydraulic setting composition comprising:
a) an aggregate comprising calcium carbonate;
b) an aggregate comprising silica;
c) alkaline hydroxide; and
d) an appropriate amount of water,
characterised in that it contains less than 20% by weight of component (c) and in that the sum of the contents of cations other than Si and Ca in components a) and b) is less than 10%.

2. The composition according to claim 1, in which the sum of the aluminium contents of components a) and b) is less than 10%.

3. The composition according to claim 1, in which the sum of the aluminium contents of components a) and b) is less than 5%.

4. The composition according to claim 1, in which the sum of the aluminium contents of components a) and b) is less than 2%.

5. The composition according to claim 1, in which the composition comprises from 0.1 to 10% by weight of component (c).

6. The composition according to claim 1, in which components (a) and (b) are supplied by a siliceous limestone aggregate.

7. The composition according to claim 1, in which component (b) is a siliceous aggregate.

8. The composition according to claim 1, in which the composition comprises from 10 to 60% by weight of each of component (a) and component (b).

9. The composition according to claim 1, in which component (c) is sodium hydroxide.

10. The composition according to claim 1, in which at least one of components (a) and (b) is or contains a waste product.

11. A process for the preparation of a monolithic material, comprising a step in which:
a composition according to claim 1 is prepared;
the composition is placed in a mould; and
the composition is allowed to harden.

12. Monolithic material obtainable by the process according to claim 11.

13. A building or repair material, comprising the monolithic material according to claim 12.
